(19) United States
(12) Patent Application Publication
(10) Pub. No.: US 2006/0050934 A1
(43) Pub. Date: Mar. 9, 2006

(54) Image search apparatus and method

(75) Inventor: Arito Asai, Asaka-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/219,855

(22) Filed: Sep. 7, 2005

(30) Foreign Application Priority Data
Sep. 8, 2004 (JP) 2004-260359

(51) Int. Cl. G06K 9/00

(52) U.S. Cl. 382/118

(57) ABSTRACT

A number of thumbnail images are displayed in the form of a thumbnail image array and a thumbnail image in which a desired face appears is selected from among these thumbnail images. Portions of the selected thumbnail image that are faces are detected in this thumbnail image, and the detected face image portions are enclosed within displayed borders. Any face image portion is selected from among the face image portions of the displayed subject image. Subject images having a face identical with the face of the selected face image portion are searched and found, and thumbnail images of these found subject images are displayed in the form of an image array. Subject images containing the image of a desired face can thus be found.

### BACKGROUND OF THE INVENTION

1. Field of the Invention

This invention relates to an image search apparatus and method.

2. Description of the Related Art

Since image search techniques using face recognition are often employed in security measures, many of these techniques improve precision. By having the user designate the part of an image that is a face, the image of the face is cut from the image (see the specification of Japanese Patent Application Laid-Open No. 2002-207741).

A problem with these techniques, however, is that the user must designate the face. This requires labor on the part of the user.

### SUMMARY OF THE INVENTION

Accordingly, an object of the present invention is to make it possible to select an image, which contains the image of a desired face, from a number of images in a comparatively simple manner.

According to a first aspect of the present invention, the foregoing object is attained by providing an image search apparatus comprising: a designating device for designating at least one image of a subject among a number of subject images; a face-image detecting device (face-image detecting means) for detecting a face image portion from the subject image that has been designated; a subject-image search device (subject-image search means) for finding subject images, which contain a face image portion identical with the face of the face image that has been detected by the face-image detecting device, from among the number of subject images; and an output device for outputting the subject images that have been found by the subject-image search device.

The first aspect of the present invention also provides a method suited to the above-described image search apparatus. Specifically, there is provided an image search method comprising the steps of: designating at least one image of a subject among a number of subject images; detecting a face image portion from the subject image that has been designated; finding subject images, which contain a face image portion identical with the face of the face image that has been detected, from among the number of subject images; and outputting the subject images that have been found.

In accordance with the first aspect of the present invention, at least one image of a subject is designated among a number of subject images, and a face image portion that is contained in the designated subject image is detected. The number of detected face image portions may be singular or plural. Subject images having a face image portion identical with the face of the detected face image portion are found among the number of subject images. The found subject images are output (i.e., the found subject images are displayed or printed, the image data representing the found subject images is output, etc.).

Preferably, the apparatus further comprises a first display device for displaying a plurality of subject images, from among the number of subject images, in the form of an array. In this case, the designating device would designate at least one subject image from among the plurality of subject images displayed on the first display device.

The output device is a second display device for displaying subject images, which have been found by the subject-image search device, one frame at a time or in the form of an array.

The second display device may display the portion of the face image, which has been detected by the face-image detecting device, in a form distinguishable from other portions in a subject image that has been found by the subject-image search device. This allows the user to ascertain in which portion of a found subject image the face image resides.

The apparatus may further comprise a third display device for displaying the designated subject image while the face image portion that has been detected by the face-image detecting device is distinguished from other portions. This makes it easier to recognize which portion is the portion of a face.

Preferably, the apparatus further comprises a selecting device which, if the face image portions are plural in number, is for selecting at least one face image portion from among the plurality of face image portions. In this case, the subject-image search device would find subject images, which contain the face image portion that has been selected by the selecting device, from among the number of subject images.

The third display device may display the face image portion, which has been selected by the selecting device, in a form distinguishable from face image portions not selected. This makes it easy to ascertain which face image portion has been selected.

Any two or all of the first display device, second display device and third display device may be the same display device.

According to a second aspect of the present invention, the foregoing object is attained by providing an image search apparatus comprising: a face-image storage device for storing the position of a face image portion located in each subject image among a number of subject images; a face-match storage device for storing the positions of face image portions, which are identical with the face of the face image portion in each subject image, among the number of subject images; a designating device for designating at least one subject image from among the number of subject images; a subject-image search device for finding subject images, which have a face image portion identical with the face of the face image portion contained in the subject image designated by the designating device, from among the number of subject images based upon the positions of the face image portions that have been stored in the face-image storage device and face-match storage device; and an output device for outputting the subject images that have been found by the subject-image search device.

The second aspect of the present invention also provides a method suited to the above-described image search apparatus. Specifically, there is provided an image search method comprising the steps of: storing the position of a face image portion in each subject image among a number of subject images, and the positions of face image portions, which are identical with the face of the face image portion in each subject image, among the number of subject images; designating at least one subject image from among the number of subject images; finding subject images, which have a face image portion identical with the face of the face image portion contained in the designated subject image, from among the number of subject images based upon the positions of the face image portions that have been stored; and outputting the subject images that have been found.

In accordance with the second aspect of the present invention, the position of a face image portion in each subject image and the position of a face image portion identical with the face of the face image portion in each subject are stored. When at least one subject image from among the number of subject images is designated, subject images, which have a face image portion identical with the face of the face image portion contained in the designated subject image, are found from among the number of subject images based upon the positions of the face image portions that have been stored. The found subject images are output.

Since the positions of face image portions have been stored, processing for detecting the position of a face image portion and processing for detecting the position of an image portion having the same face is no longer necessary. Since the load of detection processing is alleviated, the necessary subject image can be obtained quickly.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 illustrates the external appearance of an image search apparatus according to a first embodiment of the present invention;

FIG. 2 is a block diagram illustrating the electrical structure of the image search apparatus according to the first embodiment;

FIG. 3 is a flowchart illustrating processing executed by the image search apparatus according to the first embodiment;

FIGS. 4 to 6 illustrate the external appearance of the image search apparatus according to the first embodiment;

FIG. 7 is a block diagram illustrating the electrical structure of an image search apparatus according to a second embodiment of the present invention;

FIG. 8 illustrates an example of a face position table according to the second embodiment;

FIG. 9 illustrates an example of a face match table according to the second embodiment;

FIG. 10 is a flowchart illustrating processing for installing the face position table and face match table according to the second embodiment; and

FIG. 11 is a flowchart illustrating processing executed by the image search apparatus according to the second embodiment.

### DESCRIPTION OF THE PREFERRED EMBODIMENTS

Preferred embodiments of the present invention will now be described in detail with reference to the drawings.

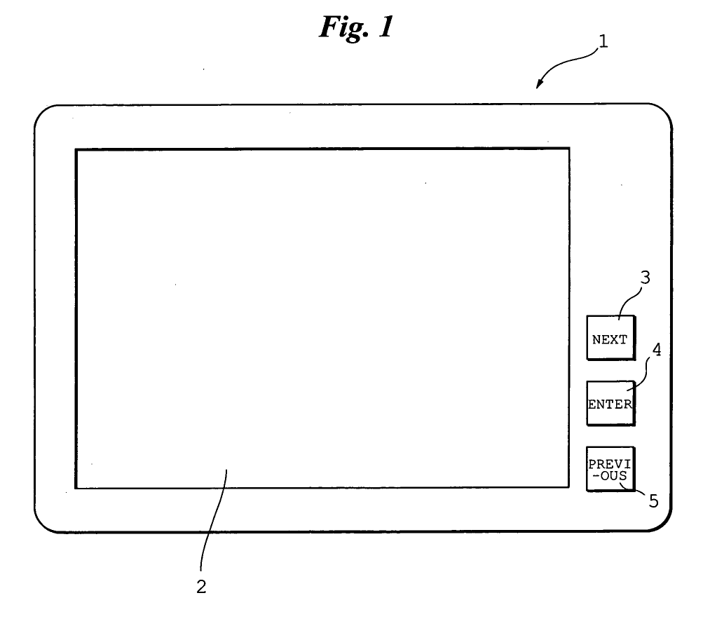

FIG. 1 illustrates the external appearance of an image search apparatus 1 according to a first embodiment of the present invention.

This image search apparatus finds image files, which contain an image identical with a face represented by the image of a desired face, from among subject images represented by a number of image files that have been stored on a memory card, and displays the subject images, which are represented by the image files found, in the form of an image array.

The image search apparatus 1 has a liquid crystal display screen 2 formed substantially over the entirety of the front side thereof. An image found by a search is displayed on the liquid crystal display screen 2 in a manner described later.

A NEXT button 3, ENTER button 4 and PREVIOUS button 5 are provided at the lower right of the display screen 2. The NEXT button 3 supplies the image search apparatus 1 with a command for moving a border or the like, which is displayed on the display screen 2, in a prescribed direction of travel (usually from right to left and from top to bottom). The ENTER button 4 provides the image search apparatus 1 with a command for finally selecting an image that has been enclosed by the border, etc. The PREVIOUS button 5 provides the image search apparatus 1 with a command for moving the border, etc., which is displayed on the display screen 2, in a direction opposite the direction in which the border is moved by the NEXT button 3.

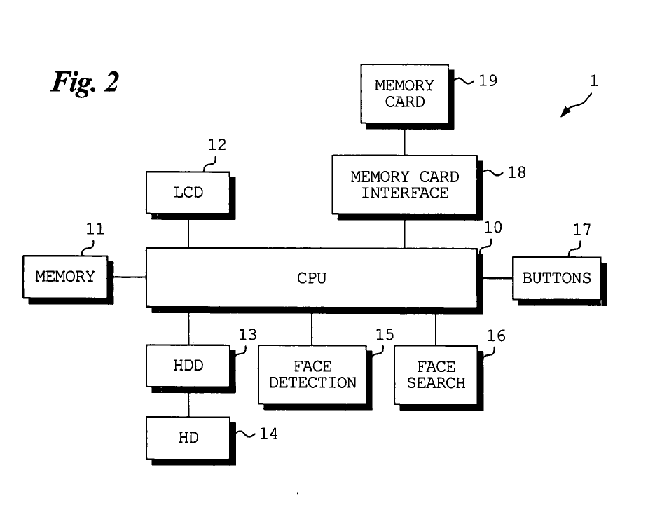

FIG. 2 is a block diagram illustrating the electrical structure of the image search apparatus 1.

The operation of the overall image search apparatus 1 is controlled by a CPU 10.

The image search apparatus 1 has a liquid crystal display device 12, which has the liquid crystal display screen 2 mentioned above, as well as buttons 17 that include the NEXT button 3, ENTER button 4 and PREVIOUS button 5. Various command signals from the buttons 17 are applied to the CPU 10.

The image search apparatus 1 includes a memory card interface 18 for loading a memory card 19. Further, the image search apparatus 1 includes a memory 11 for storing data temporarily, a hard disk 14 for storing an image file that has been read from the memory card 19, and a hard-disk drive 13 for accessing the hard disk 14.

Furthermore, in order to find subjects having the image of a face identical with a desired face, the image search apparatus 1 is provided with a face detecting unit 15 for extracting the image of a face in the image of a subject, and a face search unit 16 for finding the image of the face that has been detected by the face detecting unit 15. Data indicating degree of facial likeliness in order to extract the image of a face (face sample images, relative positions of eyes, nose and ears, etc., that construct a face, and data representing images, etc.) has been stored in the face detecting unit 15. The image of a face is found based upon the data indicating facial likeliness. Further, the face search unit 16 executes processing, which is for matching the detected image of a face and the image of a subject, while changing the size of the image of the face, and finds the images of subjects having an image identical with the face represented by the image of the face.

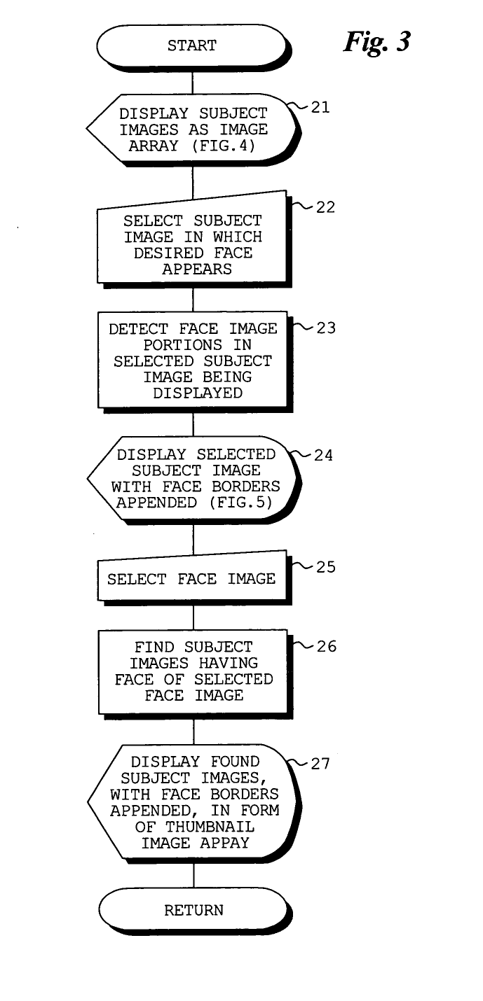

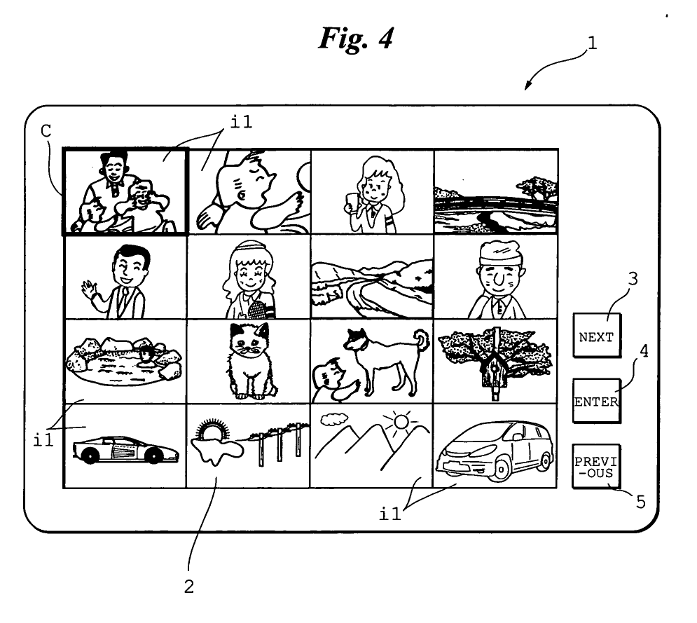

FIG. 3 is a flowchart illustrating processing executed by the image search apparatus 1, and FIGS. 4 to 6 illustrate the external appearance of the image search apparatus 1.

Assume that the memory card 19 has been loaded in the image search apparatus 1 and that a number of image files that have been recorded on the memory card 19 have been recorded on the hard disk 14.

When the power supply of the image search apparatus 1 is turned on, the number of image files that have been recorded on the hard disk 14 are read and the images (thumbnail images) represented by these image files are displayed in the form of an image array, as illustrated in FIG. 4 (step 21).

As shown in FIG. 4, a number of thumbnail images i1 are being displayed as an image array on the liquid crystal display screen 2. A subject-image border C that encloses a thumbnail image is being displayed about the periphery of the thumbnail image i1 at the upper left. If the NEXT button 3 is pressed, the border C moves so as to enclose the thumbnail image i1 on the right-hand side. If the NEXT button 3 is pressed when the thumbnail image i1 at the extreme right is being enclosed by the border C, then the border C moves so as to enclose the thumbnail image i1 at the extreme left of the immediately underlying row. If the PREVIOUS button 5 is pressed, the border C moves in the direction opposite that when the NEXT button 3 was pressed.

The user operates the NEXT button 3 and PREVIOUS button 5 in such a manner that the border C will enclose a thumbnail image i1 that contains a face desired to be found from among the number of thumbnail images i1 being displayed in the form of the array. When the thumbnail image i1 containing the face desired to be found is enclosed by the border C, the ENTER button 4 is pressed by the user. With reference again to FIG. 3, the subject image in which the desired face appears is selected by the user (step 22). Here it will be assumed that the thumbnail image i1 at the upper left of the display screen 2 in FIG. 4 has been selected by the user.

When the thumbnail image i1 is selected, the image file corresponding to the selected thumbnail image is read from the hard disk 14 and is applied to the face detecting unit 15. In the image represented by the applied image file, the portions of this image that are the images of faces are detected by the face detecting unit 15 (step 23). When detection is performed, the subject image (the image that corresponds to the selected thumbnail image i1, this image being larger than the thumbnail image), in which the areas of the face image portions detected appear comparatively brighter than the other portions of the image, is displayed on the entirety of the display screen 2 (step 24).

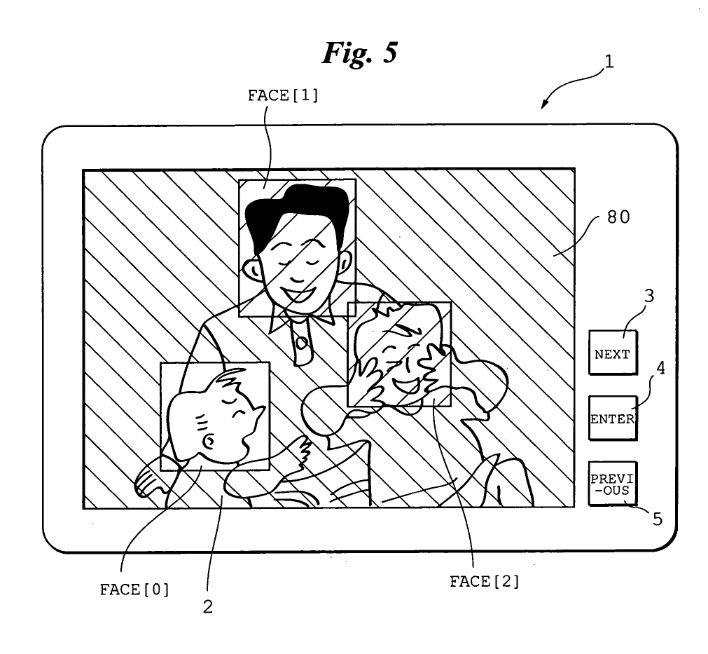

FIG. 5 illustrates a subject image 80 selected by the user and displayed on the entirety of the display screen 2.

In the selected subject image 80, the image areas (FACE [0], FACE [1] and FACE [2] from left to right in the order mentioned) of faces obtained in the face detection processing by the face detecting unit 15 are made brighter (brightness is indicated by hatching) so that they will appear different from other areas. Since the face image areas FACE [0], FACE [1] and FACE [2] are made brighter, it can be ascertained that these areas FACE [0], FACE [1] and FACE [2] have been detected as face images. One area among the areas FACE [0], FACE [1] and FACE [2] becomes the brightest in accordance with depression of NEXT button 3 and PREVIOUS button 5. In FIG. 5, the centrally located face image area FACE [1] is the brightest. If the NEXT button 3 is pressed, the face image area FACE [2] to the right becomes the brightest, and if the PREVIOUS button 5 is pressed, then the face image area FACE [0] to the left becomes the brightest. When the area containing the image of the face to be found in a search is the brightest among the face image areas FACE [0], FACE [1] and FACE [2], the ENTER button 4 is pressed. In response, subject images containing the image of the face identical with the face contained in the face image area that is the brightest are searched and found from among the number of image files. Here it will be assumed that the image area FACE [0] on the left side has been selected.

With reference again to FIG. 3, when the image of the face is selected (step 25) in the manner described above, subject images containing the image of a face identical with the image of the selected face are found from among the number of image files by the face search unit 16 (step 26). Thumbnail images of the found subject images are displayed in array form on the display screen 2 (step 27). In each thumbnail image, the portion that is face image identical with the face contained in the face image area that has been selected by the user is enclosed by a border.

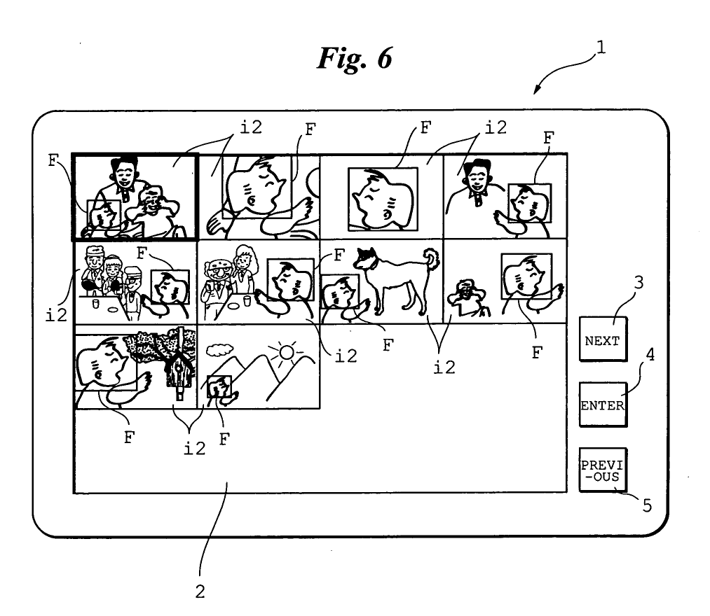

FIG. 6 illustrates the manner in which thumbnail images i2 of found subject images are displayed as an array on the display screen 2. In each thumbnail image i2, the portion that is the face image identical with the face contained in the face image area selected by the user is enclosed by a border F. By thus displaying the border F, it is possible to confirm where in each thumbnail image i2 the image of the face selected by the user is located.

Thus, subject images that contain a desired face can be found.

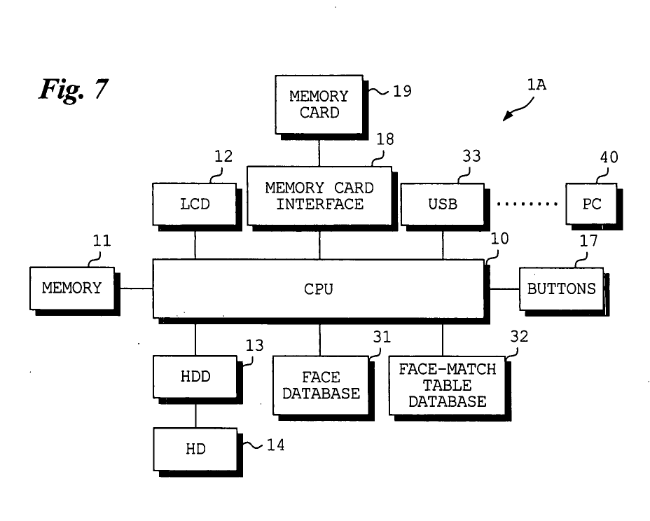

FIGS. 7 to 11 illustrate another embodiment of the present invention.

FIG. 7 is a block diagram illustrating the electrical structure of an image search apparatus 1A. Components in FIG. 7 identical with those shown in FIG. 2 are designated by like reference characters and need not be described again.

In the image search apparatus 1 of the first embodiment described above, face detection and face search are both performed by the image search apparatus 1. In the image search apparatus 1A of this embodiment, however, face detection and face search are performed by a personal computer 40 that is separate from the image search apparatus 1A. The personal computer 40 performs face detection in subject images and generates a face position table that indicates the positions of the images of faces in each subject image. The generated face position table is applied from the personal computer 40 to the image search apparatus 1A and the image search apparatus 1A stores the table in a face database 31 of the image search apparatus 1A. Further, the personal computer 40 detects also subject images that contain the image of a face identical with the image of the face represented by the detected image of the face. The personal computer 40 generates a face-match table indicating which images of faces are identical face images. The generated face-match table is applied to the image search apparatus 1A and is recorded in a face-match table database 32.

The image search apparatus 1A is provided with a USB (Universal Serial Bus) terminal 33 in order that it may be connected to the personal computer 40 as mentioned above. The image search apparatus 1A is provided with the face database 31 and face-match table database 32, as set forth above.

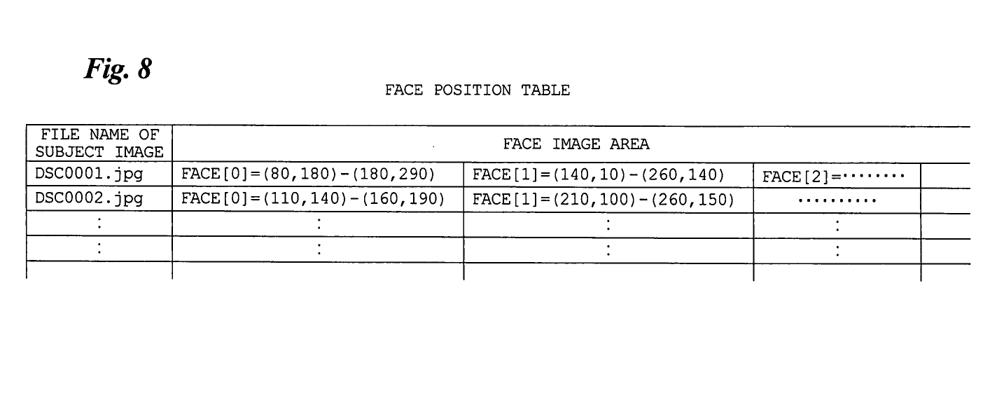

FIG. 8 illustrates the face position table.

The face position table stores, for every image of a subject, the face image areas (positions) contained in the image of the subject.

For example, the table indicates that a subject image having a file name “DSC0001.jpg” has FACE [0], FACE [1] and FACE [2] as face image areas. FACE [0] indicates a rectangular face image area specified by the coordinates (80,180) and (180,290) (see image area FACE [0] of the face on the left side in FIG. 5). Similarly, FACE [1] indicates a rectangular face image area specified by the coordinates (140,10) and (260,140) (see the central image area FACE [1] in FIG. 5). Thus, the position and size of an image area contained in each subject image can be ascertained for every subject image by referring to the face position table.

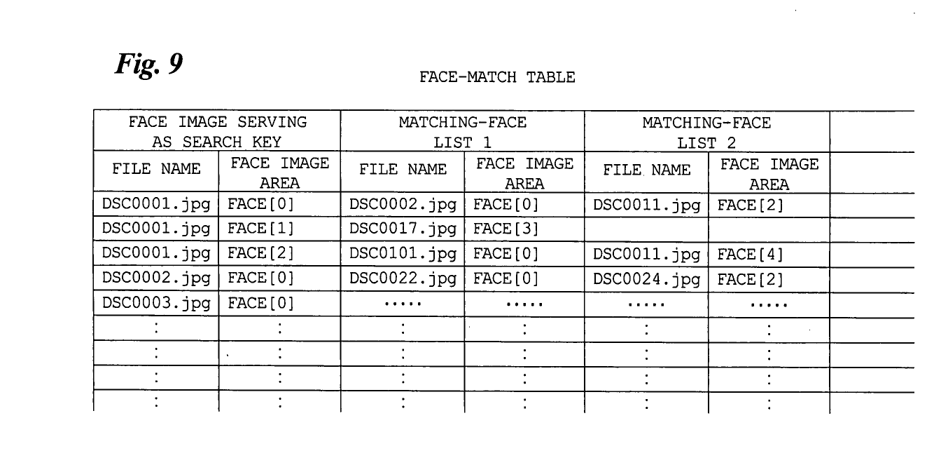

FIG. 9 illustrates the face-match table.

Among the images of faces contained in face image areas, the face-match table stores those that are identical.

Stored in the face-match table in correspondence with every face image that is a search key are a face image area having a face that is identical with the face image serving as the search key, along with the file name of the subject image that contains this face image area. For example, it will be understood that a face identical with the face of the face image contained in the face image area FACE [0] in the subject image having the file name “DSC0001.jpg” is contained in a face image area FACE [0] of a subject image having the file name “DSC0002.jpg” and in a face image area FACE [2] of a subject image having the file name “DSC0011.jpg”. The face image that has been selected by the user becomes the search key, and face image areas having the face identical with the face of the face image serving as the search key can be found by referring to the face-match table.

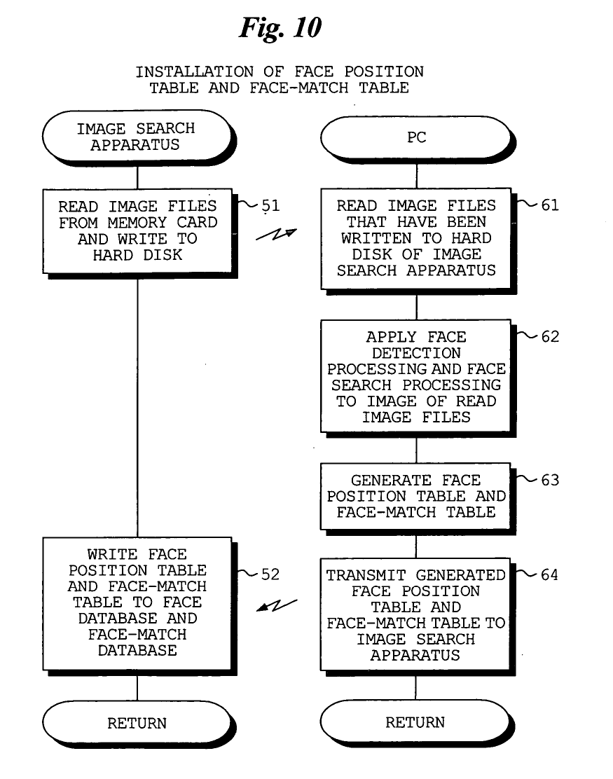

FIG. 10 is a flowchart illustrating processing for storing a face position table and face-match table in the face database 31 and face-match table database 32, respectively. It is assumed that the personal computer 40 has been connected to the image search apparatus 1A.

The memory card 19 is loaded in the memory card interface 18 and image files that have been stored on the memory card 19 are read. The read image files are written to the hard disk 14 by the hard-disk drive 13 (step 51).

When this is done, the image files that have been written to the hard disk 14 are read by the personal computer 40 (step 61). Software having the functions of the face detecting unit 15 and face search unit 16 described above have been installed in the personal computer 40, and the above-described face detection processing and face search processing is executed by the personal computer 40 (step 62). The face position table is generated by execution of the face detection processing, and the face-match table is generated by execution of the face search processing (step 63). The generated face position table and face-match table are transmitted to the image search apparatus 1A (step 64).

The face position table transmitted from the personal computer 40 is written to the face database 31, and the face-match table transmitted is written to the face-match table database 32 (step 52).

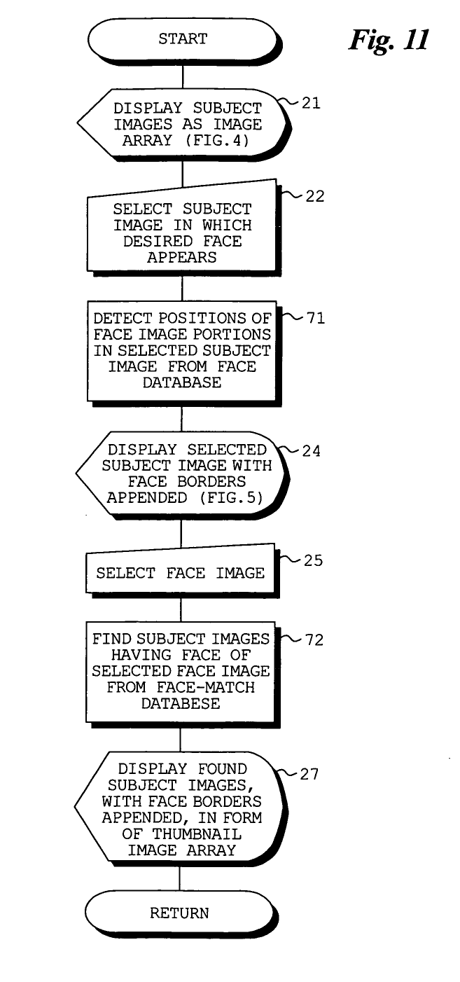

FIG. 11 is a flowchart illustrating processing executed by an image search apparatus in which the face position table and face-match table have already been stored. Processing steps in FIG. 11 identical with those shown in FIG. 3 are designated by like step numbers.

A subject image in which the desired face appears is selected from among thumbnail images displayed in array form (steps 21, 22).

The positions of the portions that are the face images in the selected subject image are detected by referring to the face database 31 (step 71). When this is done, the subject image in which face image portions are enclosed by borders is displayed (step 24), as described above. If a plurality of face image areas are included, the desired face image area is selected from among these. Face image areas having a face identical with the face of the selected face image are found by referring to the face-match table database 32 (step 72). The subject images thus found are displayed is array form, with each subject image having a face border enclosing the face (step 27).

Since the face position table and face-match table have been stored in advance, a desired subject image can be found quickly.

In the embodiments set forth above, subject images (thumbnail images) containing the image of the desired face are displayed in array form. However, it may be so arranged that the subject images are printed by providing a printer. Further, the subject images need not necessarily be displayed in array form but may be displayed or printed one frame at a time. Furthermore, it may be so arranged that image files representing the subject images are output to the external personal computer 40 or the like and stored.

Further, although the border F is displayed in the foregoing embodiments, the border need not be displayed. Furthermore, an image that has been selected in an image area in FIG. 5 appears brighter than other image areas. However, it may be so arranged that an area that has been selected can be ascertained by a border or the like, or areas other than the image area need not be made darker. Furthermore, an image area to be selected may be more than one.

As many apparently widely different embodiments of the present invention can be made without departing from the spirit and scope thereof, it is to be understood that the invention is not limited to the specific embodiments thereof except as defined in the appended claims.

What is claimed is:

1. An image search apparatus comprising:
a designating device for designating at least one image of a subject among a number of subject images;
a face-image detecting device for detecting a face image portion from the subject image that has been designated;
a subject-image search device for finding subject images, which contain a face image portion identical with the face of the face image that has been detected by said face-image detecting device, from among the number of subject images; and
an output device for outputting the subject images that have been found by said subject-image search device.

2. The apparatus according to claim 1, further comprising a first display device for displaying a plurality of subject images, from among the number of subject images, in the form of an array;
wherein said designating device designates at least one subject image from among the plurality of subject images displayed on said first display device.

3. The apparatus according to claim 1, wherein said output device is a second display device for displaying subject images, which have been found by said subject-image search device, one frame at a time or in the form of an array.

4. The apparatus according to claim 3, wherein said second display device displays the portion of the face image, which has been detected by said face-image detecting device, in a form distinguishable from other portions in a subject image that has been found by said subject-image search device.

5. The apparatus according to claim 1, further comprising a third display device for displaying the designated subject image while the face image portion that has been detected by said face-image detecting device is distinguished from other portions.

6. The apparatus according to claim 5, further comprising a selecting device which, if the face image portions are plural in number, is for selecting at least one face image portion from among the plurality of face image portions;
wherein said subject-image search device finds subject images, which contain the face image portion that has been selected by said selecting device, from among the number of subject images.

7. The apparatus according to claim 6, wherein said third display device displays the face image portion, which has been selected by said selecting device, in a form distinguishable from face image portions not selected.

8. An image search apparatus comprising:
a face-image storage device for storing the position of a face image portion in each subject image among a number of subject images;
a face-match storage device for storing the positions of face image portions, which are identical with the face of the face image portion in each subject image, among the number of subject images;
a designating device for designating at least one subject image from among the number of subject images;
a subject-image search device for finding subject images, which have a face image portion identical with the face of the face image portion contained in the subject image designated by said designating device, from among the number of subject images based upon the positions of the face image portions that have been stored in said face-image storage device and in said face-match storage device; and
an output device for outputting the subject images that have been found by said subject-image search device.

9. An image search method comprising the steps of:
designating at least one image of a subject among a number of subject images;
detecting a face image portion from the subject image that has been designated;
finding subject images, which contain a face image portion identical with the face of the face image that has been detected, from among the number of subject images; and
outputting the subject images that have been found.

10. An image search method comprising the steps of:
storing the position of a face image portion in each subject image among a number of subject images, and the positions of face image portions, which are identical with the face of the face image portion in each subject image, among the number of subject images;
designating at least one subject image from among the number of subject images;
finding subject images, which have a face image portion identical with the face of the face image portion contained in the designated subject image, from among the number of subject images based upon the positions of the face image portions that have been stored; and
outputting the subject images that have been found.
